(19) United States
(12) Patent Application Publication
(10) Pub. No.: US 2018/0282480 A1
(43) Pub. Date: Oct. 4, 2018

(54) Cashew Nutshell Liquid Alkoxylate Carboxylate as a New Renewable Surfactant Composition for Enhanced Oil Recovery Applications

(71) Applicant: Clariant International Ltd., Muttenz 1 (CH)

(72) Inventors: Dirk LEINWEBER, Kelkheim (DE); Anton KAISER, Mühldorf am Inn (DE); Jonathan WYLDE, The Woodlands, TX (US); Corinna KRUEGER, Kirchheim (DE); Hadi SHAMSI JAZEYI, The Woodlands, TX (US)

(73) Assignee: Clariant International Ltd., Muttenz 1 (CH)

(21) Appl. No.: 15/766,741

(22) PCT Filed: Oct. 7, 2016
(86) PCT No.: PCT/EP2016/074038

§ 371 Date: Apr. 6, 2018

Related U.S. Application Data
(63) Continuation of application No. 14/879,988, filed on Oct. 9, 2015, now abandoned.

(30) Foreign Application Priority Data
Nov. 2, 2015 (EP) 15192500.5

(51) Int. Cl. C08G 65/332; E21B 43/16; C09K 8/584

(52) U.S. Cl. CPC C08G 65/3322; E21B 43/16; C09K 8/584

(57) ABSTRACT

The present invention contains methods, of making a cashew nutshell liquid alkoxylate carboxylate surfactant by alkoxylation of a natural alkylphenol using propylene oxide (PO) and/or ethylene oxide (EO) followed by a carboxymethylation reaction. The cashew nutshell liquid alkoxylate sulfate surfactant of the present invention is made by a facile and cost effective method. The natural hydrophobe surfactant of the present invention find uses in EOR applications where it is used for solubilization and mobilization of oil optionally containing asphaltene, wax, naphthenate, and for environmental cleanup. Another advantage is that the composition is a renewable based surfactant that is non-toxic and biodegradable.

The present invention relates in general to the field of oil recovery, and more particularly, to a surfactant composition comprising natural based cardanol alkoxylate carboxylates and derivatives for enhanced oil recovery (EOR) applications

Enhanced Oil Recovery refers to technologies for increasing the amount of crude oil that can be extracted from a hydrocarbon containing reservoir. Methods used in the prior art include gas injection, water or steam injection, chemical injection, microbial injection and thermal methods. Enhanced Oil Recovery is described in general in several publications, for instance:
Speight, J. G. (2009) Enhanced Recovery Methods for Heavy Oil and Tar Sands, Gulf Publishing Company, Houston.
Alvarado, V. and Manrique, E. (2010) Enhanced Oil Recovery—Field Planning and Development Strategies, Elsevier, Oxford.
Sheng, J. J. (2011) Modern Chemical Enhanced Oil Recovery—Theory and Practice, Gulf Publishing Company, Houston.

Surfactants for chemical enhanced oil recovery are described in several publications, for instance:
R. Zhang, J. Zhou, L. Peng, N. Qin, Z. Je Tenside Surf. Det. 50 (2013), 3, 214-218.
R. Zhou, J. Zhao, X. Wang, Y. Yang Tenside Surf. Det. 50 (2013), 3, 175-181.
J.-L. Salager, A. M. Forgiarini, J. Bullon J Surfact Deterg (2013) 16:449-472.
J.-L. Salager, L. Marquez, L. Manchego, A. M. Forgiarini, J. Bullon J Surfact Deterg (2013) 16:631-663.

The prior art contains several approaches for methods of EOR.

EP-0264867 discloses Styrylaryloxy ether sulfonates of the formula:

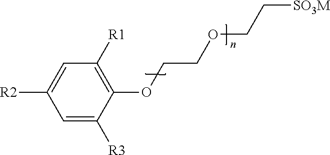

In which either R1 denotes styryl and simultaneously R2 and R3 are identical or different denote hydrogen or styryl, or R1 and R2 are nonidentical and each denote methyl or styryl and simultaneously R3 denotes hydrogen or styryl, n denotes a number from 2 to 20, and M denotes an ammonium or alkali metal cation. These compounds are suitable as surfactant auxiliaries in oil recovery.

WO 2008/079855 describes compositions and methods of treating a hydrocarbon containing formation, comprising: (a) providing a composition to at least a portion of the hydrocarbon formation, wherein the composition comprises a secondary alcohol derivative; and (b) allowing the composition to interact with hydrocarbons in the hydrocarbon containing formation. The invention further describes a composition produced from a hydrocarbon containing formation, comprising hydrocarbons from a hydrocarbon containing formation and a secondary alcohol derivative.

US-20090270281 describes the use of a surfactant mixture comprising at least one surfactant having a hydrocarbon radical composed of from 12 to 30 carbon atoms and at least one co-surfactant having a branched hydrocarbon radical composed of from 6 to 11 carbon atoms for tertiary mineral oil extraction.

According to the Steinbrenner invention, the surfactants (A) are used in a mixture with at least one co-surfactant (B) which has the general formula R2-O—(R3-O)ₙ—R4, where the R2, R3 and R4 radicals and the number n are each defined as follows: n is from 2 to 20, R2 is a branched hydrocarbon radical which has from 6 to 11 carbon atoms and an average degree of branching of from 1 to 2.5, R3 are each independently an ethylene group or a propylene group, with the proviso that the ethylene and propylene groups—where both types of groups are present—may be arranged randomly, alternately or in block structure, R4 is hydrogen or a group selected from the group of —SO₃H, —PO₃H₂, —R5-COOH, —R5-SO₃H or R5-PO₃H₂ or salts thereof, where R5 is a divalent hydrocarbon group having from 1 to 4 carbon atoms.

EP-0149173 teaches Tributylphenolether glycidylsulfonates and their use in tertiary oil recovery.

U.S. Pat. No. 8,372,788 discloses the use of Styrylphenol alkoxylate sulfate surfactant compositions for enhanced oil recovery applications.

WO 2013/159054 discloses the use of large hydrophobe quarternary ammonium surfactants in tertiary oil recovery processes.

EP-80855 and WO 2012/146607 teaches sugar based compounds and their use for enhanced oil recovery.

For Enhanced Oil Recovery (EOR), several chemical methods like the use of polymer (P), surfactant polymer (SP), alkaline surfactant polymer (ASP), alkaline surfactant (AS), alkaline polymer (AP), surfactant alkaline foam (SAF), surfactant polymer gels (ASG) and alkaline co-solvent polymer (ACP) systems have been used in the prior art. SP, AS and ASP systems comprise use of Alpha-olefin sulfonates, internal-olefin sulfonates, Alkyl-aryl sulfonates and Alkyl-ether sulfonates. For those systems a usable maximum oil reservoir temperature is about 70° C. Only in rare cases may the temperature be higher. The water salinity should be below about 35,000 ppm. This is clearly a disadvantage since many oil wells have higher temperatures and higher salinity. Problems regarding chemical injection include that the salinity of many oil fields make the extraction less efficient. The temperature in many oil fields is too high with respect to the chemicals used so that the process becomes inefficient.

In addition to high temperature and/or high salinity, problems in the prior art include that the additives are not cost effective and/or not renewable based. Further, some of the chemicals used today may be toxic and/or non-biodegradable. Further, there is improvement regarding the emulsification and dispersion capabilities of the substances according to the state of the art required.

It has been surprisingly found that the use of cashew nutshell liquid alkoxylate carboxylate surfactants wherein the cashew nutshell liquid, is majorly cardanol, for enhanced oil recovery (EOR) and other commercially important applications will overcome the problems outlined above. Said surfactants will work at temperatures up to 150° C. and in high salinity up to 300,000 ppm. They are biodegradable, non-toxic and show improved emulsification and dispersion capabilities.

In one embodiment, the present invention discloses a surfactant composition, comprising a compound according to formula (I)

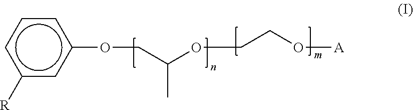

wherein
R is aliphatic hydrocarbon with 15 C-atoms having 1 to 3 double bonds or being saturated,
A is CH₂COOM
n is a number from 0 to 70,
m is a number from 0 to 150, and
M is a counter ion to the carboxylate group.

In another embodiment, the present invention provides a method for manufacturing the cardanol alkoxy carboxylate surfactant of formula (I), comprising the steps of:
(i) alkoxylating a cashew nutshell liquid with n moles of propylene oxide, m moles of ethylene oxide, or both, in the presence of an alkaline catalyst, wherein n corresponds to the number of propoxy groups and ranges from 0 to 70, wherein m corresponds to the number of ethoxy groups and ranges from 0 to 150 and
(ii) Carboxymethylating the alkoxylated cashew nutshell liquid by any carboxymethylation process to manufacture the cardanol alkoxy carboxylate surfactant.

The alkyl phenol unit in formula (I) is preferably cardanol. Cardanol is a natural product from cashew nutshells wherein R generally comprises 35-45 molar % tri-unsaturated, 18-28 molar % di-unsaturated, 30-40 molar % mono-unsaturated and 0-4 molar % saturated residues. Preferred is 41 molar % tri-unsaturated, 22 molar % di-unsaturated, 34 molar % mono-unsaturated and 2% saturated residues.

n is preferably a number between 1 and 60, more preferably between 2 and 50, particularly between 5 and 40 and most preferably between 10 and 40.

m is preferably a number between 1 and 140, more preferably between 5 and 50, and most preferably between 10 and 40.

In a preferred embodiment, m is 0 and n is a number from 1 to 70. In another preferred embodiment n is 0 and m is a number from 1 to 150.

In another preferred embodiment, (n+m) is at least 5, preferably at least 7, more preferably at least 10 and most preferably at least 15.

In one aspect of the composition, n is selected from 0, 1, 2, 3, 4, 5, 6, 7, 8, 9, 10, 12, 14, 16, 18, 20, 21, 22, 23, 24, 25, 28, 30, 35, 40, 45, 50, 55, 60, 65 or 70, and m is selected from 0, 1, 2, 3, 4, 5, 6, 7, 8, 9, 10, 12, 14, 15, 16, 18, 20, 21, 22, 23, 24, 25, 28, 30, 35, 40, 45, 50, 55, 60, 65, 70, 75, 80, 90, 100, 110, 120, 130, 140 or 150.

In another aspect of the composition of the present invention m is 0 and n is selected from 1, 2, 3, 4, 5, 6, 7, 8, 9, 10, 12, 14, 16, 18, 20, 21, 22, 23, 24, 25, 28, 30, 35, 40, 45, 50, 55, 60, 65 or 70.

In another aspect of the composition of the present invention n is 0 and m is selected from 1, 2, 3, 4, 5, 6, 7, 8, 9, 10, 12, 14, 15, 16, 18, 20, 21, 22, 23, 24, 25, 28, 30, 35, 40, 45, 50, 55, 60, 65, 70, 75, 80, 90, 100, 110, 120, 130, 140 or 150.

In a specific embodiment, n is from 30 to 40, preferably 35 and m is from 15 to 25, preferably 20.

Preferably, M is selected from the group consisting of H, Na, K, Mg, Ca, Li, Sr, Cs and NH₄. In a more preferred embodiment, M in formula (I) means Na, K, Mg, Ca and NH₄.

Preferably, the compound of formula (I) contains the ethoxy and propoxy groups blockwise, i.e. is a block alkoxylate.

Carboxymethylation should preferably be effected by a mild carboxymethylation process, e.g. carboxymethylation with chloroacetic acid or chloroacetic acid sodium salt.

The meanings of n, m, R and M as mentioned above apply to the method as well.

In a preferred embodiment, the alkaline catalyst is selected from the group consisting of KOH, NaOH, NaOMe, NH₄OH, LION, Ca(OH)₂, Sr(OH)₂, CaO, Cs(OH)₂, Mg(OH)₂ or any combination thereof.

One preferred embodiment of the present invention is directed to a method of making a cardanol alkoxy carboxylate surfactant having a formula (I), wherein n=30-40, preferably 35, m=15-25, preferably 20, A=SO₃M and M=Na comprising the steps of:
(i) propoxylating the cardanol with propylene oxide (PO) in the presence of NaOMe or any other suitable alkaline catalyst to form a propoxylated cardanol (cardanol-PO), wherein the molar ratio of cardanol:PO is 1:(30-40), preferably 1:35,
(ii) ethoxylating the propoxylated cardanol with ethylene oxide (EO) in the presence of NaOMe or any other suitable alkaline catalyst to form a cardanol-PO-EO, wherein the molar ratio of cardanol-PO:EO is 1:(15-25), preferably 1:20, and
(iii) carboxymethylation the cardanol-35PO-20EO by a chloroacetic acid carboxymethylation process to manufacture the cashew nutshell liquid alkoxy carboxylate surfactant having the formula (I).

The composition of formula (I) may be adapted for enhanced oil recovery (EOR), environmental ground water cleanup, crude oil emulsion breaking, and other surfactant based applications. Adaption means that the number of EO and PO groups is chosen so as to give the composition of formula (I) efficiency for enhanced oil recovery (EOR), environmental ground water cleanup, crude oil emulsion breaking, and other surfactant based applications.

In one aspect the cashew nutshell liquid alkoxy carboxylate surfactant of formula (I) is adapted via optimization of the PO and EO ratios for enhanced oil recovery (EOR), environmental ground water cleanup, crude oil emulsion breaking, and other surfactant based applications. For enhanced oil recovery applications the PO/EO molar ratio is preferably (1.5-2.5):1, more preferably about 2:1.

Another embodiment of the present invention discloses a composition for use in enhanced oil recovery (EOR), environmental ground water cleanup, crude oil emulsion breaking, and other surfactant based operations, comprising one or more compositions of formula (I), one or more alkalinity generating agents, and a solvent, wherein the cardanol alkoxy carboxylate surfactants and the alkalinity generating agents are dissolved in the solvent.

Preferably, the alkalinity generating agents comprise at least one component selected from alkaline earth metal hydroxides, NaOH, NaOMe, KOH, LiOH, NH₄OH, Na₂CO₃, NaOAc, NaHCO₃, CaCO₃, Na-metaborate, Na-silicates, Na-orthosilicates, EDTANa₄, other polycarboxylates, or any combination thereof.

Preferably, the solvent comprises at least one component selected from water, hard brine, hard water, polymer containing solutions, gas foam or any combinations thereof. In yet another aspect, the composition is adapted via optimization of the PO and EO ratios for use alone, in an alkaline-surfactant-polymer formulation or surfactant-polymer formulation for EOR applications. In one preferred embodiment the composition for enhanced oil recovery applications comprises PO and EO in a molar ratio of preferably (1.5-2.5):1, more preferably about 2:1. In one aspect the composition contains from 0.1 wt.-% to 5 wt.-% of the one or more alkalinity generating agents.

In another aspect, the composition for use in enhanced oil recovery (EOR), environmental ground water cleanup, crude oil emulsion breaking, and other surfactant based operations is adapted for EOR from a crude oil, wherein the crude oil comprises paraffin rich crude oils, asphaltene rich crude oils or combinations and mixtures thereof. In yet another aspect, the composition is adapted for EOR from hydrocarbon bearing formations having a high content in an asphaltene rich crude oil. In a preferred embodiment for these applications, a compound of Formula (I) with n=30-40, preferably 35, m=15-25, preferably 20, and M=Na is used.

In yet another embodiment, the present invention describes a method of enhanced oil recovery (EOR) from a hydrocarbon bearing formation comprising the steps of: injecting a composition comprising a compound of formula (I) into the hydrocarbon bearing formation at a temperature from 25 to 150° C., wherein the composition of formula (I) is in water, hard water or hard brine and comprises between 0.01 to 5 wt.-% of one or more alkalinity generating agents and injecting a polymer solution or the gas foam to recover the oil. In this method, the compound of formula (I) may be used alone, as an alkaline-surfactant-polymer (ASP) formulation or as a gas foam. The polymer solution is known as a “push” solution.

Another embodiment of the present invention relates to a method of recovering an asphaltene and paraffin rich crude oil from a hydrocarbon bearing formation comprising the steps of injecting a composition comprising a compound of formula (I) into the hydrocarbon bearing formation at a temperature from 25 to 150° C., wherein the composition of formula (I) is in water, hard water or hard brine and comprises greater than 0.01-5 wt.-% of one or more alkalinity generating agents and injecting a polymer solution or the gas foam to recover the oil. In this method, the compound of formula (I) may be used alone, as an alkaline-surfactant-polymer (ASP) formulation or as a gas foam. The polymer solution is known as a “push” solution.

An ASP formulation in the meaning of this invention is a formulation comprising the compound according to formula 1 together with the solution of a polymer, and with an alkaline compound. The polymer is used to increase the viscosity of the solution. The alkaline compound is used to provide a pH level of above 7, preferably 8-14.

The present invention describes a novel renewable based composition for enhanced oil recovery (EOR) applications. The composition described herein is preferably a cashew nutshell liquid alkoxylate sulfate surfactant. Cashew nutshell liquid (CNSL) majorly consists of cardanol, a phenolic lipid obtained from anacardic acid, a nonfood competing renewable wastestream of the cashew nut processing. Cardanol finds use in the chemical industry in resins, coatings, frictional materials, and surfactants used as pigment dispersants for water-based inks. The name cardanol is used for the decarboxylated derivatives obtained by thermal decomposition of any of the naturally occurring anacardic acids. This includes more than one compound because the composition of the side chain varies in its degree of unsaturation.

Formula (II) shows the chemical heterogeneity of the cardanol alkenyl/alkyl side chain. The alkenyl/alkyl-side chain consists of 15 C-atoms of which around 35-45 molar % are tri unsaturated, 18-28 molar % are di-unsaturated, 30-40 molar % are mono-unsaturated and 0-4 molar % are saturated residues. Preferred is 41 molar % tri-unsaturated, 22 molar % di-unsaturated, 34 molar % mono-unsaturated and 2% saturated residues.

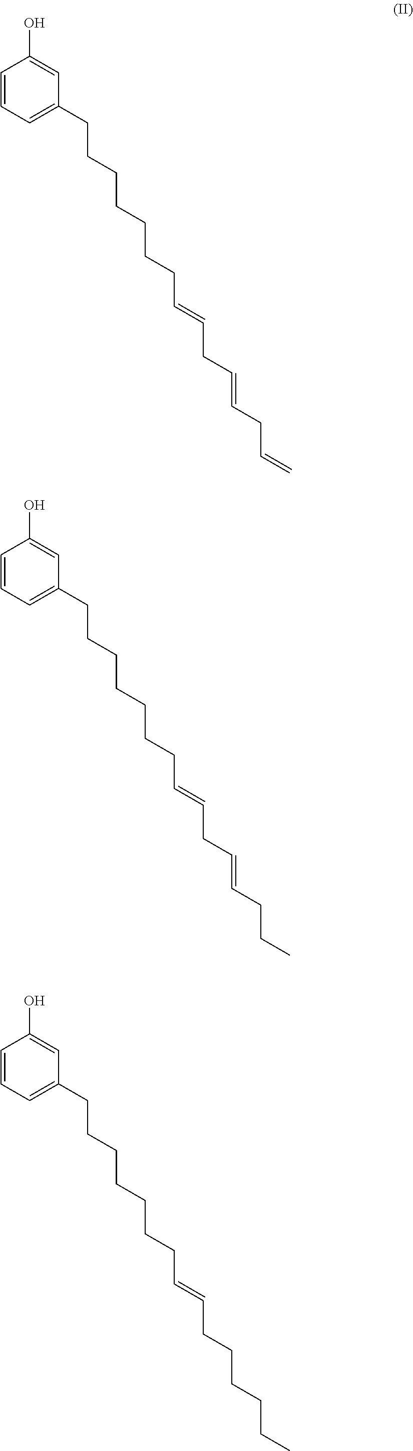 [SMILES: C=CC/C=C/C/C=C/CCCCCCCc1cccc(O)c1 ; CCC/C=C/C/C=C/CCCCCCCc1cccc(O)c1 ; CCCCCC/C=C/CCCCCCCc1cccc(O)c1]

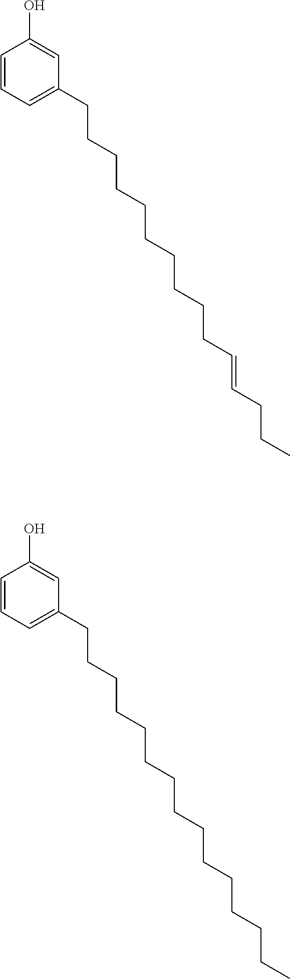 [SMILES: CCC/C=C/CCCCCCCCCCc1cccc(O)c1 ; CCCCCCCCCCCCCCCc1cccc(O)c1]

The exact composition varies from the source and the region where the cashew nuts are grown. The physical properties of cardanol are comparable to nonylphenol. Cardanol is hydrophobic and remains flexible and liquid at very low temperatures. Its freezing point is below −20° C., it has a density of 0.930 g/mL, and boils at 225° C. under reduced pressure (10 mmHg). Cardanol is a commercially readily available, natural, largely hydrophobic mixture. It is a phenol and as such easily amenable to alkoxylation with alkylene oxides such as propylene oxide (PO), ethylene oxide (EO) or both. After alkoxylation, the cardanol alkoxylate may be sulfated to produce a highly effective and efficient anionic surfactant for EOR applications.

It has been found that a compound according to formula I, particularly in the form of cardanol-35PO-20EO-carboxylate, is an excellent surfactant for solubilizing crude oil in brine. Said surfactant of the present invention has a great affinity to the asphaltene and paraffin containing crude oils due to the high alkenyl/alkyl-aromatic nature of the natural cashew nutshell liquid surfactant hydrophobic moiety, thus enabling an enhanced recovery of the asphaltene and paraffin rich crudes from a hydrocarbon bearing formation.

The advantageous technical effect of using the compounds of formula (I) arises from the unique heterogenic natural C₁₅ alkenyl and alkyl side chain (residue R in formula (I)) distribution as part of the hydrophobic moiety, the size of which can be further enhanced by the addition of alkylene oxides such as PO. The superior hydrophobicity is balanced by an equally large EO block in combination with an anionic carboxylate group to reach a desired hydrophilic-lipophilic balance (HLB) for the surfactant.

Usually, large hydrophobe anionics are inherently less soluble in aqueous media necessitating the use of co-solvents which in turn increases the optimal salinity. This issue is addressed by the compounds of formula (I) that have good aqueous solubility while maintaining high surface activity. Thus, the need for co-solvents is obviated or minimized for improving the water solubility of the surfactant formulation. A co-solvent, if used, may serve other purposes such as improvement of the viscosity of the middle phases, promoting faster equilibration etc.

Carboxymethylation of a functionalized alcohol is one of the most versatile methods of making anionic surfactants. Consequently, a new array of anionic surfactants that can find applications in high temperature reservoir EOR applications becomes available. Carboxymethylation, by virtue of its simplicity, is the most feasible method of incorporating anionic functionality in a surfactant.

The present invention can be used in any application (e.g. surface or near-surface treatments, down hole or Enhanced Oil Recovery) that involves low to high temperature conditions, such as, environmental clean-up of ground water contaminated by oils and other organic solvents. In addition, the compounds of formula (I) are applicable to cleaning and aquifer remediation work.

### General Procedure for the Alkoxylation of Cardanol:

A 1 L alkoxylation autoclave was charged with cardanol and alkalyzed with sodium methylate solution to an alkaline value of 1.5 mg KOH/g substance. The autoclave was inertized by nitrogen, pressure tested and heated up to 125° C. Nitrogen pressure was adjusted to 0.8-1.0 bar and at maximum 130° C. the calculated amount of alkylene oxide was added up to a maximum pressure of 3.5 bar. After finished addition of alkylene oxide the reaction autoclave was heated at 130° C. until the pressure remained constant.

### General Procedure for the Ethoxylation of Cardanol Propoxylates:

A 1 L alkoxylation autoclave was charged with cardanol propoxylate and alkalyzed with sodium methylate solution to an alkaline value of 2.5 mg KOH/g substance. The autoclave was inertized by nitrogen, pressure tested and heated up to 135° C. Nitrogen pressure was adjusted to 0.8-1.0 bar and at maximum 140° C. the calculated amount of ethylene oxide was added up to a maximum pressure of 4.5 bar. After finished addition of EO the reaction autoclave was heated at 140° C. until the pressure remained constant.

### General Procedure for the Sulfation of Cardanol Alkoxylates:

### General Procedure for the Carboxymethylation of Cardanol Alkoxylates:

A 1 L reaction vessel was charged with cardanol alkoxylate and heated up to 80° C. Chloroacetic acid sodium salt was added followed by equimolar amounts of NaOH and the reaction mixture was heated up to 110° C. for 8 hours. Afterwards, the product was cooled to ambient temperature.

A reference to percentages means % by weight, unless otherwise specified.

For methods of treating a hydrocarbon-bearing formation and/or a well bore may include, but are not limited to placing a chemical (e.g. fluorochemical, cationic polymer, or corrosion inhibitor) within a hydrocarbon-bearing formation using any suitable manner known in the art (e.g. pumping, injecting, pouring, releasing, displacing, spotting, or circulating the chemical into a well, well bore, or hydrocarbon-bearing formation).

“Crude oil” as used herein encompasses, but is not limited to oleaginous materials such as those found in the oil field deposits, oil shales, heavy oil deposits, and the like. “Crude oil” generally refers to a mixture of naturally occurring hydrocarbons that is refined into diesel, gasoline, heating oil, jet fuel, kerosene, and literally many other products called petrochemicals. Crude oil is named according to its contents and origins, and classified according to its per unit weight (specific gravity). Heavier crudes yield more heat upon burning, but have lower API gravity and market price in comparison to light (or sweet) crudes.

“Crude oil” varies widely in appearance and viscosity from field to field. It ranges in color, odor, and in the properties contained within. While all crude oil is essentially hydrocarbons, the differences in properties, especially the variations in molecular structure, determine whether a “crude oil” is more or less easy to produce, pipeline, and refine. The variations may even influence its suitability for certain products and the quality of those products. “Crude oil” is roughly classified into three groups, according to the nature of the hydrocarbon it contains:
(i) Paraffin based crude oil contains higher molecular weight paraffin's which are solid at room temperature, but little or no asphaltic (bituminous) matter. They can produce high-grade lubricating oils,
(ii) Asphaltene based crude oil contains large proportions of asphaltic matter, and little or no paraffin. Some are predominantly naphthenes and so yield lubricating oils that are more sensitive to temperature and pH changes than the paraffin-based crudes, and
(iii) Mixed based crude oil contains both paraffins and naphthenes, as well as aromatic hydrocarbons. Most crudes fit into this category.

Within chemical flooding methods alkaline surfactant polymer flooding or surfactant polymer flooding may include, but are not limited to the method of mixing long chain polymer molecules such as polyacrylates, polyacrylamides, partially hydrolyzed polyacrylamides or polysaccharides with the injected water in order to increase the water viscosity to a level as close to the oil viscosity as possible. This method improves the vertical and areal sweep efficiency as a consequence of improving the water/oil mobility ratio. “Polymer” may include, but is not limited to a molecule having a structure that essentially includes the multiple repetitions of units derived, from molecules of low relative molecular mass.

### Phase Behavior Procedures

Phase Behavior Screening: Phase behavior experiments have been used to characterize chemicals for EOR. There are many benefits in using phase behavior as a screening method. Phase behavior studies are used to determine:

(1) the effect of electrolytes;

(2) oil solubilization, Interfacial Tension (IFT) reduction,

(3) microemulsion densities;

(4) surfactant and microemulsion viscosities;

(5) coalescence times;

(6) identify optimal surfactant-cosolvent formulations; and/or

(7) identify optimal formulation for coreflood studies.

A thermodynamically stable phase can form with oil, water and surfactant mixtures. Surfactants form micellar structures at concentrations above the critical micelle concentration (CMC). The emulsion coalesces into a separate phase at the oil-water interface and is referred to as a microemulsion. A microemulsion is a surfactant-rich distinct phase consisting of surfactant, oil and water and possibly co-solvents and other components. This phase is thermodynamically stable in the sense that it will return to the phase volume at a given temperature. Some skilled persons in the past have added additional requirements, but for the purposes of this engineering study, the only requirement will be that the microemulsion is a thermodynamically stable phase.

The phase transition is examined by keeping all variables fixed except for the scanning variable. The scan variable is changed over a series of pipettes and may include, but is not limited to, salinity, temperature, chemical (surfactant, alcohol, electrolyte), oil, which is sometimes characterized by its equivalent alkane carbon number (EACN), and surfactant structure, which is sometimes characterized by its hydrophilic-lipophilic balance (HLB). The phase transition was first characterized by Winsor (1954) into three regions: Type I—excess oleic phase, Type III—aqueous, microemulsion and oleic phases, and Type II—excess aqueous phase. The phase transition boundaries and some common terminology are described as follows: Type I to III—lower critical salinity, Type III to II—upper critical salinity, oil solubilization ratio (Vo/Vs), water solubilization ratio (Vw/Vs), the solubilization value where the oil and water solubilization ratios are equal is called the Optimum Solubilization Ratio (σ*), and the electrolyte concentration where the optimum solubilization ratio occurs is referred to as the Optimal Salinity (S*).

Determining Interfacial Tension (IFT): Efficient use of time and lab resources can lead to valuable results when conducting phase behavior scans. A correlation between oil and water solubilization ratios and interfacial tension was suggested by Healy and Reed (1976) and a theoretical relationship was later derived by Chun Huh (1979). Lowest oil-water IFT occurs at optimum solubilization as shown by the Chun Huh theory. This is equated to an interfacial tension through the Chun Huh equation, where IFT varies with the inverse square of the solubilization ratio:

$$γ = \frac{c}{{σ}^{2}} \qquad ( 1 )$$

For most crude oils and microemulsions, C=0.3 is a good approximation. Therefore, a quick and convenient way to estimate IFT is to measure phase behavior and use the Chun-Huh equation to calculate IFT. The IFT between microemulsions and water and/or oil can be very difficult to measure and is subject to larger errors, so using the phase behavior approach to screen hundreds of combinations of surfactants, co-surfactants, co-solvents, electrolytes, oil and so forth is not only faster, but avoids the measurement problems and errors associated with measuring IFT especially of combinations that show complex behavior (gels and so forth) and will be screened out anyway. Once a formulation having the desired properties has been identified, measurement of its IFT would be prudent.

Equipment: Phase behavior experiments are created with the following materials and equipment.

Mass Balance: Mass balances are used to measure chemicals for mixtures and determine initial saturation values of cores.

Water Deionizer: Deionized (DI) water is prepared for use with all the experimental solutions using a Nonopure™ filter system. This filter uses a recirculation pump and monitors the water resistivity to indicate when ions have been removed. Water is passed through a 0.45 micron filter to eliminate undesired particles and microorganisms prior to use.

Borosilicate Pipettes: Standard 10 mL borosilicate pipettes with 0.1 mL markings are used to create phase behavior scans as well as run dilution experiments with aqueous solutions. Ends are sealed using a propane and oxygen flame.

Pipette Repeater: An Eppendorf Repeater Plus® instrument is used for most of the pipetting. This is a handheld dispenser calibrated to deliver between 25 microliter and 1 mL increments. Disposable tips are used to avoid contamination between stocks and allow for ease of operation and consistency.

Propane-Oxygen Torch: A mixture of propane and oxygen gas is directed through a Bernz-O-Matic flame nozzle to create a hot flame about 0.5 inch long. This torch is used to flame-seal the glass pipettes used in phase behavior experiments.

Convection Ovens: Several convection ovens are used to incubate the phase behaviors and core flood experiments at the reservoir temperatures. The phase behavior pipettes are primarily kept in Blue M and Memmert ovens that are monitored with thermometers and oven temperature gauges to ensure temperature fluctuations are kept at a minimal between recordings. A large flow oven was used to house most of the core flood experiments and enabled fluid injection and collection to be done at reservoir temperature.

pH Meter: An ORION research model 701/digital ion analyzer with a pH electrode is used to measure the pH of most aqueous samples to obtain more accurate readings. This is calibrated with 4.0, 7.0 and 10.0 pH buffer solutions. For rough measurements of pH, indicator papers are used with several drops of the sampled fluid.

Phase Behavior Calculations: The oil and water solubilization ratios are calculated from interface measurements taken from phase behavior pipettes. These interfaces are recorded over time as the mixtures approached equilibrium and the volume of any macroemulsions that initially formed decreased or disappeared. The procedure for creating phase behavior experiments will be discussed later.

Oil Solubilization Ratio: The oil solubilization ratio is defined as the volume of oil solubilized divided by the volume of surfactant in microemulsion. All the surfactant is presumed to be in the emulsion phase. The oil solubilization ratio is applied for Winsor type I and type III behavior. The volume of oil solubilized is found by reading the change between initial aqueous level and excess oil (top) interface level. The oil solubilization parameter is calculated as follows:

$${σ}_{0} = \frac{{V}_{0}}{{V}_{S}} \qquad ( 2 )$$

σ₀=oil solubilization ratio
V₀=volume of oil solubilized
V_{S}=volume of surfactant

Water Solubilization Ratio: The water solubilization ratio is defined as the volume of water solubilized divided by the volume of surfactant in microemulsion. All the surfactant is presumed to be in the emulsion phase. The water solubilization ratio is applied for Winsor type Ill and type II behavior. The volume of water solubilized is found by reading the change between initial aqueous level and excess water (bottom) interface level. The water solubilization parameter is calculated as follows:

$${σ}_{W} = \frac{{V}_{W}}{{V}_{S}} \qquad ( 3 )$$

σ_{W}=water solubilization ratio
V_{W}=volume of water solubilized
V_{S}=volume of surfactant

Optimum Solubilization Ratio: The optimum solubilization ratio occurs where the oil and water solubilization is equal. The coarse nature of phase behavior screening often does not include a data point at optimum, so the solubilization curves are drawn for the oil and water solubilization and the intersection of these two curves are drawn for the oil water solubilization and the intersection of these two curves is defined as the optimum. The following is true for the optimum solubilization ratio:

σ₀=σ_{W}=σ* (4)
σ*=optimum solubilization parameter

Phase Behavior Methodology: The methods for creating, measuring and recording observations are described in this section. Scans are made using a variety of electrolyte mixtures described below. Oil is added to most aqueous surfactant solutions to see if a microemulsion formed, how long it took to form and equilibrate if it formed, what type of microemulsion formed and some of its properties such as viscosity. However, the behavior of aqueous mixtures without oil added is also important and is also done in some cases to determine if the aqueous solution is clear and stable over time, becomes cloudy or separated into more than one phase.

Preparation of samples: Phase behavior samples are made by first preparing surfactant stock solution and combining them with brine stock solutions in order to observe the behavior of the mixtures over a range of salinities. All the experiments are created at or above 0.1 wt.-% active surfactant concentration, which is above the typical CMC of the surfactant.

Solution Preparation: Surfactant stocks are based on active weight-percent surfactant (and co-surfactant when incorporated). The masses of surfactant, co-surfactant, co-solvent and de-ionized water (DI) are measured out on a balance and mixed in glass jars using magnetic stir bars. The order of addition is recorded on a mixing sheet along with actual masses added and the pH of the final solution. Brine solutions are created at the necessary weight percent concentrations for making the scans.

Surfactant Stock: The chemicals being tested are first mixed in a concentrated stock solution that usually consisted of a primary surfactant, co-solvent and/or co-surfactant along with de-ionized water. The quality of chemical added is calculated based on activity and measured by weight percent of total solution. Initial experiments are at about 1-3% active surfactant so that the volume of the middle microemulsion phase would be large enough for accurate measurements assuming a solubilization ratio of at least 10 at optimum salinity.

Polymer Stock: Often these stocks were quite viscous and made pipetting difficult so they are diluted with de-ionized water according to improve ease of handling. Mixtures with polymer are made only for those surfactant formulations that showed good phase behavior and merited additional study for possible testing in core floods. Consequently, scans including polymer are limited since they are done only as a final evaluation compatibility with the surfactant.

Pipetting Procedure: Phase behavior components are added volumetrically into 10 mL pipettes using an Eppendorf Repeater Plus® or similar pipetting instruments. Surfactant and brine stocks are mixed with DI water into labeled pipettes and brought to temperature before agitation. Almost all of the phase behavior experiments are initially created with a water oil ratio (WOR) of 1:1, which involved mixing 2 mL of the aqueous phase with 2 mL of the evaluated crude oil or hydrocarbon, and different WOR experiments are mixed accordingly. The typical phase behavior scan consisted of 10-20 pipettes, each pipette being recognized as a data point in the series.

Order of Addition: Consideration had to be given to the addition of the components since the concentrations are often several fold greater than the final concentration. Therefore, an order is established to prevent any adverse effects resulting from surfactant or polymers coming into direct contact with the concentrated electrolytes. The desired sample compositions are made by combining the stocks in the following order:
(1) Electrolyte stock(s);
(2) De-ionized water;
(3) Surfactant stock;
(4) Polymer stock; and
(5) Crude oil or hydrocarbon. Any air bubbles trapped in the bottom of the pipettes are tapped out (prior to the addition of surfactant to avoid bubbles from forming).

Initial Observations: Once components are added to the pipettes, sufficient time is allotted to allow all the fluid to drain down the sides. Then aqueous fluid levels are recorded before the addition of oil. These measurements are marked on record sheets. Levels and interfaces are recorded on these documents with comments over several days and additional sheets are printed as necessary.

Sealing and Mixing: The pipettes are blanketed with argon gas to prevent the ignition of any volatile gas present by the flame sealing procedure. The tubes are then sealed with the propane-oxygen torch to prevent loss of additional volatiles when placed in the oven. Pipettes are arranged on the racks to coincide with the change in the scan variable. Once the phase behavior scan is given sufficient time to reach reservoir temperature (15-30 minutes), the pipettes are inverted several times provide adequate mixing. Tubes are observed for low tension upon mixing by looking at droplet size and how uniform the mixture appeared. Then the solutions are allowed to equilibrate over time and interface levels are recorded to determine equilibration time and surfactant performance.

Measurements and Observations: Phase behavior experiments are allowed to equilibrate in oven that is set to the reservoir temperature for the crude oil being tested. The fluid levels in the pipettes are recorded periodically and the trend in the phase behavior observed over time. Equilibrium behavior is assumed when fluid levels ceased within the margin of error for reading the samples.

Fluid Interfaces: The fluid interfaces are the most crucial element of phase behavior experiments. From them, the phase volumes are determined and the solubilization ratios are calculated. The top and bottom interfaces are recorded as the scan transitioned from an oil-in-water microemulsion to a water-in-oil microemulsion. Initial readings are taken one day after initial agitation and sometimes within hours of agitation if coalescence appeared to happen rapidly.

Measurements are taken thereafter at increasing time intervals (for example, one day, four days, one week, two weeks, one month and so on) until equilibrium is reached.

### EXAMPLES

Percentages are weight percent unless noted otherwise.

TABLE 1
Cardanol + PO + EO + Carboxylate

| | | | mole chloroacetic |
|---|---|---|---|
| | | | acid sodium salt per |
| Sample # | mole PO | mole EO | Cardanol-PO-EO mole |
| 1 | 35 | 20 | 1.1 |
| 2 | 35 | 30 | 1.1 |
| 3 | 35 | 40 | 1.1 |
| 4 | 35 | 50 | 1.1 |
| 5 | 10 | 10 | 1.1 |
| 6 | 10 | 20 | 1.1 |
| 7 | 20 | 10 | 1.1 |
| 8 | 20 | 20 | 1.1 |
| 9 | 50 | 20 | 1.1 |
| 10 | 50 | 30 | 1.1 |
| 11 | 50 | 50 | 1.1 |
| 12 | 50 | 70 | 1.1 |
| 13 | 50 | 100 | 1.1 |
| 14 | 50 | 150 | 1.1 |
| 15 | 75 | 75 | 1.1 |
| 16 (C) | 0 | 5 | 1.1 |
| 17 (C) | 0 | 10 | 1.1 |
| 18 (C) | 7 | 0 | 1.1 |
| 19 (C) | 10 | 0 | 1.1 |

The alkoxylates 18 and 19 turned out to be insoluble in water. They will transfer only into the oil phase and do not contribute to the microemulsion.

TABLE 2
Microemulsion phase behavior of 2% sample 1

| NaCl Concentration | Oil Solubilization | Oil Solubilization |
|---|---|---|
| (wt %) | (cc/cc) OIL | (cc/cc) WATER |
| 0 | 1 | |
| 2 | 2 | |
| 4 | 3 | |
| 6 | 6 | |
| 8 | 10 | |
| 10 | 18 | 80 |
| 12 | 35 | 35 |
| 14 | 50 | 8 |
| 16 | | 4 |
| 18 | | 3 |
| 20 | | 2 |

TABLE 3
Microemulsion phase behavior with 2% alkaline generating
agent sodium hydroxyde of 2% sample 1

| NaCl Concentration | Oil Solubilization | Oil Solubilization |
|---|---|---|
| (wt %) | (cc/cc) OIL | (cc/cc) WATER |
| 0 | 5 | |
| 2 | 8 | |
| 4 | 12 | |
| 6 | 16 | |
| 8 | 25 | |
| 10 | 45 | 92 |
| 12 | 71 | 67 |
| 14 | | 37 |
| 16 | | 8 |
| 18 | | 4 |
| 20 | | 1 |

TABLE 4
Microemulsion phase behavior of 2% sample 16

| NaCl Concentration | Oil Solubilization | Oil Solubilization |
|---|---|---|
| (wt %) | (cc/cc) OIL | (cc/cc) WATER |
| 0 | 0 | |
| 2 | 0 | |
| 4 | 0 | 1 |
| 6 | 0 | 3 |
| 8 | 0 | 6 |
| 10 | 0 | 6 |
| 12 | 0 | 6 |
| 14 | 2 | 6 |
| 16 | 5 | 4 |
| 18 | | 4 |
| 20 | | 1 |

The IFT calculated from Chun-Huh's formula as previously described is as follows

Sample 1 without alkali

$${σ}_{0} = \frac{{V}_{O}}{{V}_{S}} ( {cm}^{3} \text{/} {cm}^{3} ) = 0.3 / {35}^{2} = 2.449 \times {10}^{- 4}$$

σ₀=1.66×10⁻⁴ Sample 1 with alkali

σ₀=0.312 Sample 16 without alkali

A σ₀ of 10⁻³ or less is considered to be ultra low IFT.

In general, a solubilization ratio of 10 cc/cc of oil in the microemulsion phase or higher is regarded as reflecting a system with ultra-low IFT.

### BRIEF DESCRIPTION OF THE DRAWINGS

FIG. 1 is a solubilization plot for the system comprising 0.15% C₁₅₋₁₇ ABS (Alkylbenzenesulfonic acid salt), 0.15% cardanol-35PO-20EO Sulfate, 0.15% Butylglycol.

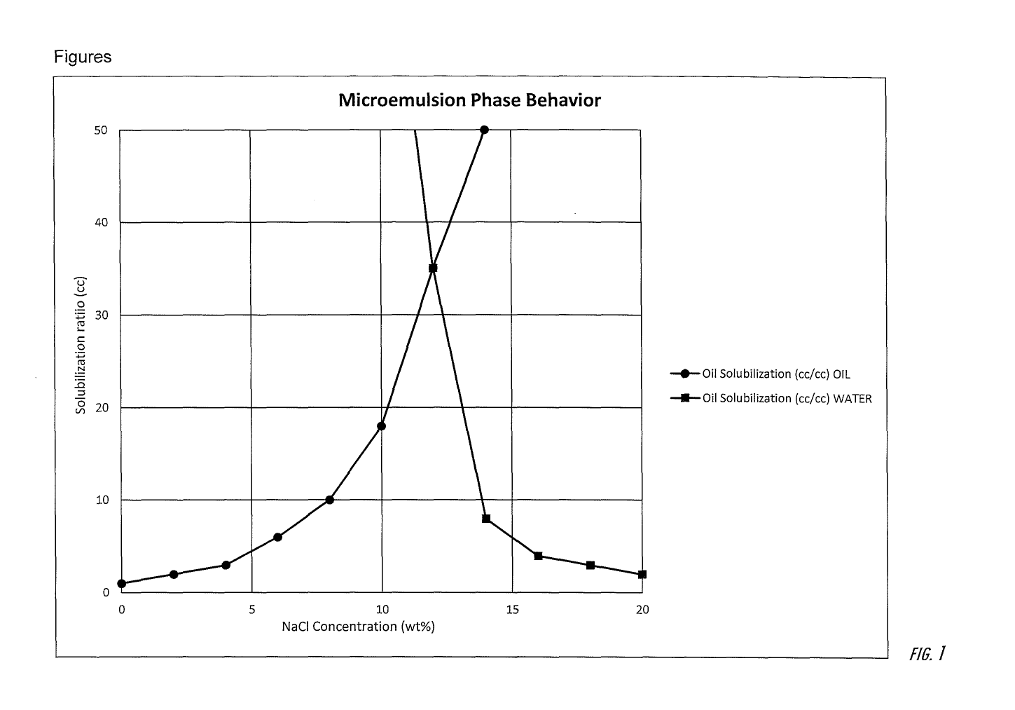

1.-24. (canceled)

25. A composition of formula (I) 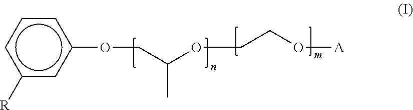
wherein
R is aliphatic hydrocarbon with 15 C-atoms having 1 to 3 double bonds or being saturated,
A is CH₂COOM
n is a number from 1 to 70,
m from 1 to 150, and
M is a counter ion to the carboxylate group.

26. The composition according to claim 25, wherein n is a number from 2 to 60.

27. The composition according to claim 25, wherein m is a number from 2 to 140.

28. The composition of claim 25, wherein n is 1, 2, 3, 4, 5, 6, 7, 8, 9, 10, 12, 14, 16, 18, 20, 21, 22, 23, 24, 25, 28, 30, 35, 40, 45, 50, 55, 60, 65 or 70.

29. The composition of claim 25, wherein m is 1, 2, 3, 4, 5, 6, 7, 8, 9, 10, 12, 14, 15, 16, 18, 20, 21, 22, 23, 24, 25, 28, 30, 35, 40, 45, 50, 55, 60, 65, 70, 75, 80, 90, 100, 110, 120, 130, 140 or 150.

30. The composition of claim 25, wherein n is 30 to 40, and m is 15 to 25.

31. The composition of claim 25, wherein M is selected from the group consisting of H, Li, Na, K, Mg, Ca, Sr, and NH₄.

32. The composition of claim 25, wherein of all residues R, 35-45 molar % are tri-unsaturated, 18-28 molar % are di-unsaturated, 30-40 molar % are mono-unsaturated and 0-4 molar % are saturated.

33. A method of making a composition of formula (I) 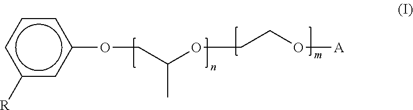
wherein
R is aliphatic hydrocarbon with 15 C-atoms having 1 to 3 double bonds or being saturated,
A is CH₂COOM
n is a number from 1 to 70,
m from 1 to 150, and
M is a counter ion to the carboxylate group,
comprising the steps of alkoxylating a cashew nutshell liquid comprising Cardanol with 1 to 70 moles of propylene oxide and 1 to 150 moles of ethylene oxide in the presence of a basic catalyst, and subsequently carboxymethylating the alkoxylated Cardanol.

34. The method of claim 33, wherein carboxymethylation is effected by reacting the alkoxylated Cardanol with chloroacetic acid.

35. The method of claim 33, wherein the basic catalyst is KOH, NaOH, NaOMe, LiOH, NH₄OH, SrOH₂, CaOH₂ or any combination thereof.

36. The method of claim 33, wherein the number of ethylene oxide units is 15 to 25, and the number of propylene oxide units is 30 to 40.

37. The method of claim 36, comprising the steps of:
propoxylating the Cardanol with propylene oxide (PO) in the presence of KOH or any other suitable alkaline catalyst to form a propoxylated Cardanol, wherein the mole ratio of the Cardanol:PO is 1:(30 to 40);
ethoxylating the propoxylated Cardanol with ethylene oxide (EO) in the presence of KOH or any other alkaline catalyst to form a Cardanol-PO-EO, wherein the mole ratio of the Cardanol-PO:EO is 1:(15 to 25); and
carboxymethylating the Cardanol-PO-EO by a chloroacetic acid, or its salts, carboxymethylation process to make the Cardanol alkoxy carboxylate surfactant having the formula Cardanol-PO-EO-CH₂COO-M.

38. A composition comprising at least one composition according to claim 25, one or more alkalinity generating agents, and a solvent, wherein the at least one composition and the one or more alkalinity generating agents are dissolved in the solvent.

39. The composition of claim 38, wherein the one or more alkalinity generating agents comprise alkaline earth metal hydroxides, NaOH, NaOMe, LiOH, KOH, NH₄OH, Na₂CO₃, NaHCO₃, NaOAc, CaCO₃, Na-metaborate, Na-silicate, Na-orthosilicate, EDTANa₄, other polycarboxylates or any combinations thereof.

40. The composition of claim 38, wherein the solvent comprises water, hard brine, hard water, polymer containing solutions, gas foam or any combinations thereof.

41. The composition of claim 38, wherein the composition contains from 0.1 to 5 wt.-% alkalinity generating agents.

42. A method of enhanced oil recovery (EOR) from a hydrocarbon bearing formation comprising the steps of:
injecting a composition of formula (I) 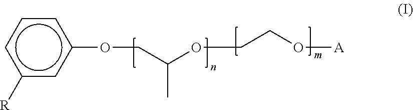
wherein
R is aliphatic hydrocarbon with 15 C-atoms having 1 to 3 double bonds or being saturated,
A is CH₂COOM
n is a number from 1 to 70,
m from 1 to 150, and
M is a counter ion to the carboxylate group
into the hydrocarbon bearing formation at a temperature from 25 to 150° C., wherein the composition is present in water, hard water or hard brine, and further comprises more than 0.05 wt.-% of one or more alkalinity generating agents; and
injecting a polymer solution or a gas foam to recover the oil.

43. The method of claim 42, wherein the one or more alkalinity generating agents comprise alkali earth metal hydroxides, NaOH, NaOMe, LiOH, KOH, NH₄OH, Na₂CO₃, NaHCO₃, NaOAc, CaCO₃, Na-metaborate, Na-silicate, Na-orthosilicate, EDTANa₄, other polycarboxylates or any combinations thereof.

44. The method of claim 42, wherein the hydrocarbon bearing formation comprises one or more paraffin based crude oils, asphaltene based crude oils, naphthenate based crude oils or combinations and mixtures thereof.
